(19) United States
(12) Patent Application Publication
(10) Pub. No.: US 2017/0115685 A1
(43) Pub. Date: Apr. 27, 2017

(54) ADAPTAIVE INERTIAL CONTROL METHOD OF WIND GENERATOR

(71) Applicant: INDUSTRIAL COOPERATION FOUNDATION CHONBUK NATIONAL UNIVERSITY, Jeollabuk-do (KR)

(72) Inventors: Yong Cheol KANG, Jeonju-si (KR); Mo Se KANG, Jeonju-si (KR); Jin Shik LEE, Jeonju-si (KR)

(21) Appl. No.: 14/893,815

(22) PCT Filed: Jul. 6, 2015
(86) PCT No.: PCT/KR2015/006921

§ 371 Date: Nov. 24, 2015

(30) Foreign Application Priority Data
Jul. 15, 2014 (KR) 10-2014-0089077
Jul. 1, 2015 (KR) 10-2015-0094058

(51) Int. Cl. G05F 5/00; F03D 9/00

(52) U.S. Cl. CPC G05F 5/00; F03D 9/002

(57) ABSTRACT

An output power control method of a wind generator includes: when a disturbance occurs, increasing output power of the wind generator by adding the active power proportional to kinetic energy stored in the wind generator at the instant of a disturbance, wherein the increasing of output power calculates an increment of the output power by using a mechanical input curve and an electrical output curve at a corresponding wind speed of the wind generator, and the increment of the output power is determined as a constant which makes the mechanical input curve of the wind generator and the electrical output curve intersect at least at one point according to each input wind speed, and when an intersection determined above is formed at a rotor speed lower than ωₘᵢₙ, the increment of the output power is determined as a maximum constant value which makes the rotor speed reach a predetermined point.

### TECHNICAL FIELD

The present invention relates to an output power control method of a wind generator, and more specifically, to an output power control method for decreasing reduction of a system frequency by temporarily increasing output power of the wind generator when a disturbance occurs in a system.

### BACKGROUND ART

As the penetration level of wind power generation increases across the world owing to improvement in viability and technologies of the wind power generation, characteristics of power grids are gradually changed. One of them is a phenomenon of reduction of system inertia.

A variable speed wind generator, such as a Doubly Fed Induction Generator (DFIG), generally performs Maximum Power Point Tracking (MPPT) control in order to maximize production of power, and Maximum Power Point Tracking control causes output of the wind generator not to correspond to the system frequency. Since such a control method reduces system inertia, a frequency nadir increases if a disturbance occurs, and even the frequency stability and system reliability can be lowered.

In order to solve such problems, methods related to frequency control of the variable speed wind generator have been proposed. For example, there is a method of producing the active power proportional to a rate of change of frequency (ROCOF) by a wind generator when the frequency is reduced, by adding a ROCOF loop to the active power controller of a DFIG converter. Although this method may suppress reduction of the system frequency, it may act as an obstacle after the frequency rebounds.

In order to make up for the disadvantages of the method described above, a method of additionally producing the active power proportional to an amount of change of frequency by a wind generator when the frequency is reduced, by adding a loop for calculating an amount of change of frequency to the loop for calculating a rate of change of frequency, also has been proposed. According to this method, contribution to the frequency control can be enhanced.

Meanwhile, a step-wise output inertial control method for producing power for ten seconds by adding 0.1 p.u. of the rated power to the output power from a wind generator at the instant of a disturbance also has been proposed. After ten seconds, the active power which is 0.05 p.u. smaller than the output power at the instant of a disturbance, is consistently maintained for twenty seconds in order to recover the reduced rotor speed. However, a second frequency dip occurs in the system due to the rapid drop of power in the process of recovering the rotor speed.

The step-wise inertial control method of the prior art abruptly reduces output power in order to prevent over-deceleration of the generator. This may act as another disturbance to the system and generate a second frequency dip. Particularly, since the output power reduction phenomenon due to the disablement of inertial control caused by the over-deceleration of the wind generator may cause further larger second frequency dip, it may give a bad influence on the frequency stability of the system. Furthermore, the prior art has a limit in that the kinetic energy of each wind generator which varies due to the wake effect cannot be considered to the inertial control in a wind power plant.

### DISCLOSURE

### Technical Problem

Therefore, the present invention has been made in view of the above problems, and it is an object of the present invention to minimize reduction of system frequency while preventing an over-deceleration phenomenon of a wind generator when a disturbance occurs.

Simultaneously, another object of the present invention is to prevent a second frequency dip of a system which occurs due to abrupt reduction of output power of a wind generator when inertial control is performed.

### Technical Solution

To accomplish the above objects, according to one aspect of the present invention, there is provided an inertial control method of a wind generator, the method including the step of increasing, when a disturbance occurs, output power of the wind generator by adding the active power proportional to kinetic energy stored in the wind generator at the instant of a disturbance to an output power reference used for MPPT control of the wind generator.

The output power increasing step may calculate an increment of the output power by using a mechanical input curve and an electrical output curve at a corresponding wind speed of the wind generator.

In an embodiment of the present invention, the output power increasing step may increase output power of the wind generator by adding the increment of the output power calculated in proportion to rotor speed of the wind generator at the instant of a disturbance to an output power reference for MPPT control.

On the other hand, in another embodiment of the present invention, when a wind power plant including multiple wind generators is controlled, the output power increasing step may increase output power of each wind generator in proportion to the kinetic energy stored in the rotor of each wind generator at the instant of a disturbance, and, at this point, the kinetic energy may be proportional to input wind speed of each wind generator reflecting the wake effect.

Meanwhile, the output power increasing step may decrease or increase the increment of the output power when the wind speed decreases or increases during the inertial control.

The output power increasing step may increase the output power by reflecting a control range of the rotor speed of the wind generator, and, more specifically, the increment of the output power may be determined as a constant value which makes the mechanical input curve of the wind generator and the electrical output curve during inertial control intersect at least at one point according to each input wind speed. However, when the intersection determined above is formed at a rotor speed lower than ωₘᵢₙ, the increment of the output power may be determined as a maximum constant value which makes the rotor speed reach a predetermined point such as the minimum operating limit.

Meanwhile, the increment of the output power may be determined by multiplying a value set in proportion to the kinetic energy by a weighting factor proportional to a maximum rate of change of system frequency.

The electrical output curve reflecting the increment of the output power according to an embodiment of the present invention may be determined by

P_{ref}=[Σₘ₌₀(kₙ₋ₘ*ω^{n-m})]+α*ΔP.

### Advantageous Effects

According to the present invention, frequency reduction can be minimized while preventing over-deceleration of a wind generator when a disturbance occurs, and a second frequency dip due to the reduction of output power of the wind generator can be prevented when inertial control is performed.

### DESCRIPTION OF DRAWINGS

FIG. 1 is a view showing an exemplary model of a wind power plant and system for simulating an adaptive inertial control method of a wind generator according to an embodiment of the present invention.

FIGS. 2 to 4 are graphs showing simulation results according to the present invention and the prior art.

FIG. 5 is a graph showing operational characteristics of adaptive inertial control of a wind generator according to an embodiment of the present invention.

FIG. 6 is a graph showing operational characteristics of adaptive inertial control of a wind generator according to another embodiment of the present invention.

### MODE FOR INVENTION

Details of the objects and technical configuration of the present invention described above and operational effects according thereto will be clearly understood hereinafter by the detailed description with reference to the accompanying drawings attached in the specification of the present invention.

The present invention will be described hereinafter in detail with reference to the accompanying drawings.

Unlike the conventional method mentioned in the [Background of the Related Art], the adaptive inertial control method of a wind generator according to the present invention increases output power of the wind generator in proportion to the rotor speed at the instant of a disturbance.

If a disturbance occurs in a system and its frequency is reduced, the method mentioned in the [Background of the Related Art] (Prior art document 3) increases the active power output at the instant of a disturbance by a specific value (0.1 p.u.) and maintains the active power for a predetermined time (e.g., ten seconds). After the predetermined time is elapsed, the method decreases the active power at the instant of a disturbance by a specific value (0.05 p.u.) and maintains the active power for a predetermined time (e.g., twenty seconds). The method of the prior art copes with occurrence of a disturbance by maintaining the active power of a specific magnitude regardless of a state of the wind generator for a predetermined time.

For reference, the disturbance mentioned in the present invention is a situation of reducing the frequency due to shortage of the active power in the power system, which means abrupt increase of load or a case of tripping a synchronous generator in operation.

Various methods are introduced above in the [Background of the Related Art] to solve the problem, and the present invention solves the problem by a method completely different from the methods already known to the public.

The present invention increases output power of a wind generator at the instant of a disturbance, i.e., at the instant of frequency reduction, in proportion to the rotor speed of the generator at the instant of a disturbance. The output power of the wind generator is determined in proportion to the cube of the rotor speed when the wind speed is lower than a rated wind speed (within a range of wind speed for wind generator operation), and the rotor speed of the generator is proportional to the wind speed. That is, expressing the present invention in a another way, a wind generator which generates large power before a disturbance occurs (a generator possessing a high kinetic energy) is controlled to release more power (kinetic energy) when the disturbance occurs. This is different from the method of the prior art (which consistently generates the active power added with a preset constant value for a specific time), which copes with a disturbance considering an operating condition (the rotor speed at the instant of a disturbance) of the wind generator.

In an embodiment of the present invention, in increasing the output power in proportion to the rotor speed of the generator, the output power can be increased by adding an increment of output power calculated in proportion to the rotor speed of the generator at the instant of a disturbance to an output power reference for Maximum Power Point Tracking control.

If this embodiment is expressed as a mathematical expression, it is as shown below in [Mathematical expression 1].

P_{ref}−P_{MPPT}+ΔP [Mathematical expression 1]

In [Mathematical expression 1], P_{MPPT} denotes output power of a wind generator according to Maximum Power Point Tracking control, and ΔP is an increment of the output power of the wind generator when a disturbance occurs and has a constant value. As described above, ΔP is proportional to the rotor speed of the wind generator at the instant of a disturbance. In addition, P_{ref} denotes output power of the wind generator after occurrence disturbance according to an output power control method of the present invention.

Although a conventional method (particularly, prior art document 3) controls a wind generator to maintain a specific output power determined in advance for a predetermined time, instead of the Maximum Power Point Tracking control, in this embodiment, the output power can be increased immediately right after a disturbance occurs and a second frequency dip also can be prevented by adding an increment of output power proportional to the rotor speed at the instant of a disturbance to an output power reference for Maximum Power Point Tracking control.

On the other hand, in an embodiment of the present invention, in increasing output power of a wind generator in proportion to kinetic energy, the output power can be increased by reflecting a control range of the rotor speed of the wind generator.

In another embodiment of the present invention, in increasing output power of a wind generator in proportion to a rate of change of system frequency or an amount of change of frequency of the wind generator, not to the kinetic energy, the output power can be increased by reflecting a control range of the rotor speed of the wind generator.

The active power added in proportion to the kinetic energy is determined as an output power which can be produced to the maximum value within a range in which the rotor speed is not reduced below a minimum speed (an operating limit) while the wind generator performs inertial control. That is, in the case of a wind generator having a high kinetic energy due to a high rotor speed, the added active power is calculated to be high, and contrarily, in the case of a wind generator having a low kinetic energy due to a low rotor speed, the added active power is calculated to be low. If an example of a method of calculating ΔP of [Mathematical expression 1] according to this embodiment is expressed as a mathematical expression, it is shown below in [Mathematical expression 2].

$${\int }_{{ω}^{*}}^{{ω}_{min}} ( {P}_{ref} - {P}_{mech} ) d ω = 0 \qquad [ Mathematical expression 2 ]$$

In [Mathematical expression 2], P_{mech} denotes a mechanical input of a wind generator. Details of the mathematical expression may vary according to the characteristics of the wind generator or a method of defining P_{mech}. On the other hand, the form of [Mathematical expression 2] may vary according to whether or not damping is considered.

Meanwhile, P_{MPPT} of [Mathematical expression 1] can be expressed as kω³ (the value of coefficient k may vary according to the control mode of the wind generator, and when P_{MPPT} is expressed as a mathematical expression of a form proportional to the cube of ω, it should be regarded as having a meaning mathematically the same as P_{MPPT} of [Mathematical expression 1]). Accordingly, [Mathematical expression 1] and [Mathematical expression 2] can be expressed as [Mathematical expression 3] shown below, and AP can be derived as [Mathematical expression 4] based on [Mathematical expression 3].

$$[ Mathematical expression 3 ]$$

$${\int }_{{ω}^{*}}^{{ω}_{min}} k {ω}^{3} d ω + {\int }_{{ω}^{*}}^{{ω}_{min}} Δ P d ω - {\int }_{{ω}^{*}}^{{ω}_{min}} {P}_{mech} d ω = 0 \\ [ Mathematical expression 4 ]$$

$$Δ P = \frac{1}{{ω}^{*} - {ω}_{min}} [ {\int }_{{ω}^{*}}^{{ω}_{min}} k {ω}^{3} d ω - {\int }_{{ω}^{*}}^{{ω}_{min}} {P}_{mech} d ω ]$$

Accordingly, the present invention may calculate output power increased for inertial control through an output power reference and mechanical input of a wind generator so that the total sum of the difference between the mechanical input and electrical output may become zero, considering the operating limit of the wind generator.

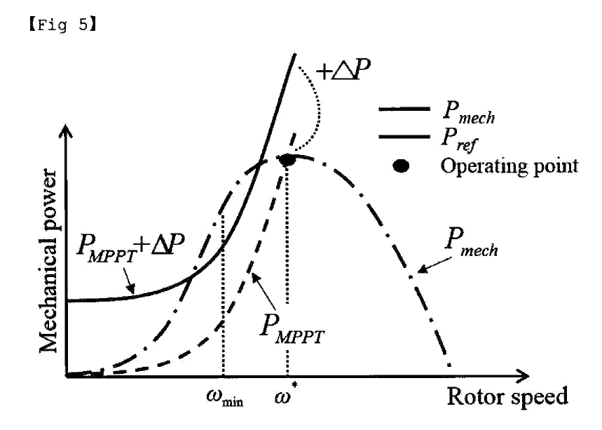

If this embodiment is expressed on a graph, it can be expressed as shown in FIG. 5.

The dash-dotted line of FIG. 5 is a curved line showing mechanical input power of a wind generator, and the dashed line is the output power according to the Maximum Power Point Tracking control, and the solid line is an output curve reflecting the output power increased according to an embodiment of the present invention. The present invention controls the wind generator so that the total sum of the difference between the mechanical input power and the electrical output power according to inertial control may become zero (which is expressed as [Mathematical expression 2]) in a section between ωₘᵢₙ and ω*.

Meanwhile, although the output power is expressed as a mathematical expression related to power in [Mathematical expression 1] to [Mathematical expression 4], the output power can be expressed as a mathematical expression related to other factors having the same technical meaning such as a torque. That is, in addition to the output control method described above in this specification as an example, performing inertial control using various factors for controlling output power should be also regarded as belonging to the present invention.

Meanwhile, although ΔP for inertial control is calculated in this embodiment assuming that ωₘᵢₙ and ω* are a minimum operating speed and an optimum operating speed, respectively, ΔP also can be calculated when other values are used for ωₘᵢₙ and ω*. That is, even when the wind generator does not operate in the MPPT control mode and thus the rotor speed is not ω*, ΔP can be obtained by substituting the current rotor speed for ω* of [mathematical expression 4]. In addition, although ΔP is calculated within a limit which does not allow deceleration below 0.7 p.u. assumed by setting the operating limit of the wind generator to ωₘᵢₙ, ΔP can be calculated by setting a specific rotor speed larger than ωₘᵢₙ as a limit speed according to the purpose of the control.

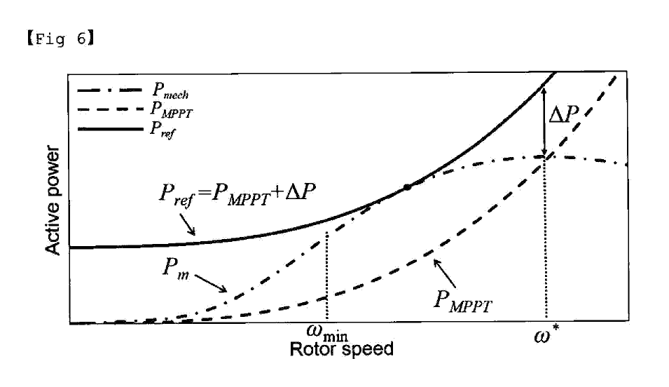

On the other hand, ΔP can be calculated through the characteristic curve of FIG. 6, unlike the method of [Mathematical expression 4]. At this point, ΔP calculated by [Mathematical expression 4] is determined as a value where the deceleration area becomes equal to the acceleration area (a value where the total sum of the difference between the input curve and the output curve is zero) in FIG. 5, whereas ΔP, i.e., an increment of output power, calculated through the characteristic curve of FIG. 6 decreases or increases in proportion to the wind speed when the wind speed increases or decreases while inertial control is performed, i.e., it is calculated to intersect the mechanical input curve and the electrical output curve at one point at a corresponding wind speed, and this is a point where the difference between the mechanical input and the electric output becomes zero, i.e., a point where the rotor speed converges, and it means a point where dωr/dt converges to zero.

If this embodiment is expressed as a mathematical expression, it is shown below.

P_{ref}=f(ω)+α*ΔP (where, f(ω)=kₙωⁿ+kₙ₋₁ωⁿ⁻¹+ . . . +kₙ₋ₘω^{n-m})

This can be expressed as shown below in [Mathematical expression 5].

P_{ref}=└Σₘ₌₀(kₙ₋ₘ*ω^{n-m})┘+α*ΔP [Mathematical expression 5]

In [Mathematical expression 5], n is a rational number which does not have a value equal to or smaller than zero, m is an integer equal to or larger than zero, α is a weighting factor reflecting a value proportional to the maximum rate of change of system frequency.

On the other hand, if n=3, α=1 and m=0 in [Mathematical expression 5] expressing the electric output curve, this should be regarded as having a meaning mathematically the same as that of [Mathematical expression 1].

When the maximum increment of output power is calculated in the method described above, ΔP is increased until the two curves meet at one point, and thus ΔP having a value larger than the value calculated in the method described above (Mathematical expression 4) can be calculated.

On the other hand, in an embodiment of the present invention, in increasing output power of a wind generator in proportion to kinetic energy, the output power can be increased by reflecting a control range of the rotor speed of the wind generator.

In addition, the output power can be increased by multiplying the increment of output power calculated in proportion to the kinetic energy by a value proportional to the maximum rate of change of system frequency as a weighting factor and reflecting the control range of the rotor speed of the wind generator.

In other words, ΔP is calculated considering the mechanical input curve and the electrical output curve (generally, an MPPT control curve) determined by input wind speed of the wind generator. More specifically, ΔP which makes the mechanical input power curve and the electrical output power curve of the wind generator, which are drawn on a plane of the active power and rotor speed of the wind generator, intersect at one point is calculated, and this will be described in detail with reference to FIG. 6.

FIG. 6 shows a graph of the active power and the rotor speed of a wind generator, in which the dash-dotted line is a mechanical input power curve of the wind generator, the dashed line is an MPPT control curve, and the solid line is an electrical output power curve of the present invention. Since ΔP calculated in the present invention is a constant, it performs a function of vertically increasing the MPPT control reference value when inertial control is performed, and the electrical output power curve determined in this way is the solid line. The present invention determines ΔP to intersect the mechanical input power curve (dash-dotted line) and the electrical output power curve (solid line) of the wind generator at one point. Since the meaning of intersecting the two curves at one point is showing a point where the rotor speed of the wind generator does not decrease any more during the inertial control, over-deceleration caused by the inertial control can be avoided if the present invention is applied. Furthermore, the output curve (solid line) shows that the output power is smoothly reduced as a rate of change of output power (dP/dt) is decreased since the rotor speed is reduced due to the releasement of kinetic energy. Therefore, the inertial control can be performed without generating a second frequency dip after a disturbance occurs. Accordingly, the present invention may calculate an increment of output power for inertial control through the electrical output curve and the mechanical input curve of the wind generator within a range that the rotor speed of the wind generator does not reach the minimum speed limit.

Since the input curve and the output curve are convex upward and downward, respectively, they have two intersections if the ΔP value is not a maximum. When the intersections of the two curves are formed at a point where the rotor speed is below ωₘᵢₙ, ΔP is reduced. At this point, OP is set to the maximum value of ΔP which forms the intersections of the two curves at win or at a set point, i.e., a point above ωₘᵢₙ according to the control limit of the wind generator. That is, if the present invention is applied, the wind generator converges at ωₘᵢₙ or above in, and thus frequency reduction can be prevented below ωₘᵢₙ due to the inertial control, and, accordingly, a second frequency dip also can be prevented.

The mechanical input characteristics of the wind generator determined according to the input wind speed and the electrical output characteristics determined according to the rotor speed for MPPT control are reflected to determine AP, and, accordingly, ΔP can be calculated in advance with respect to each optimum rotor speed, and this value is proportional to the input wind speed (or ω*) into the wind generator. That is, it is characterized in that if kinetic energy of the rotor of the wind generator is high, ΔP is calculated to be high to increase the level of contribution, and if kinetic energy of the rotor is low, ΔP is calculated to be low.

Meanwhile, although ΔP for inertial control is calculated in this embodiment assuming that output of the wind generator is operated in the MPPT control mode before a disturbance occurs, if the wind generator is not operated in the MPPT control mode, ΔP can be obtained by substituting a corresponding electrical output function for the P_{MPPT} of FIG. 6.

Also in this case, an increment of output power can be calculated to intersect the mechanical input curve and the electrical output curve at one point, and if this point is formed below the minimum speed, ΔP is calculated as a maximum value to have an intersection at the minimum speed or higher.

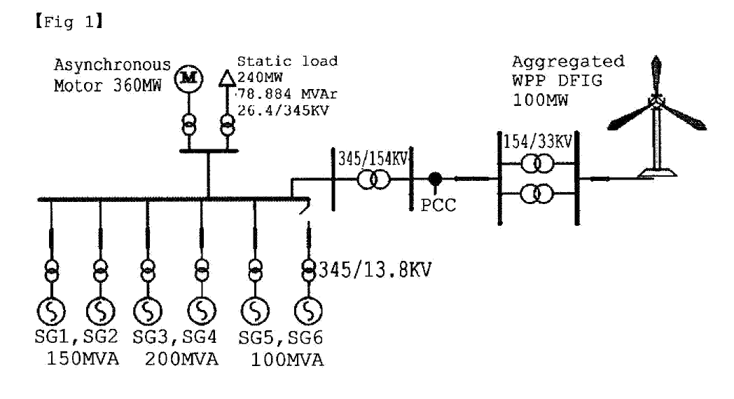

FIG. 1 is a view showing an exemplary model of a wind power plant and system for simulating an adaptive inertial control method of a wind generator according to an embodiment of the present invention.

The system shown in FIG. 1 is configured of six synchronous generators using a steam governor, a wind power plant including twenty 5 MW DFIGs, an induction machine consuming 240 MW, and a fixed load consuming 360 MW. The wind power plant is implemented by using an equivalent DFIG model, and this power plant is integrated to the system through two 60 MVA main transformers and a submarine cable. The cut-in, rated and cut-out wind speeds of the DFIG are 4 m/s, 11 m/s, and 25 m/s, respectively, and the operating rotor speed range of the wind generator is 0.7 to 1.25 p.u. In order to simulate reduction of system frequency caused by a disturbance, a synchronous generator generating 70 MW is tripped at 40 seconds.

A case study of a wind generator having a penetration level of 16.7% is performed when the wind speed is 11 m/s, 9 m/s and 7 m/s.

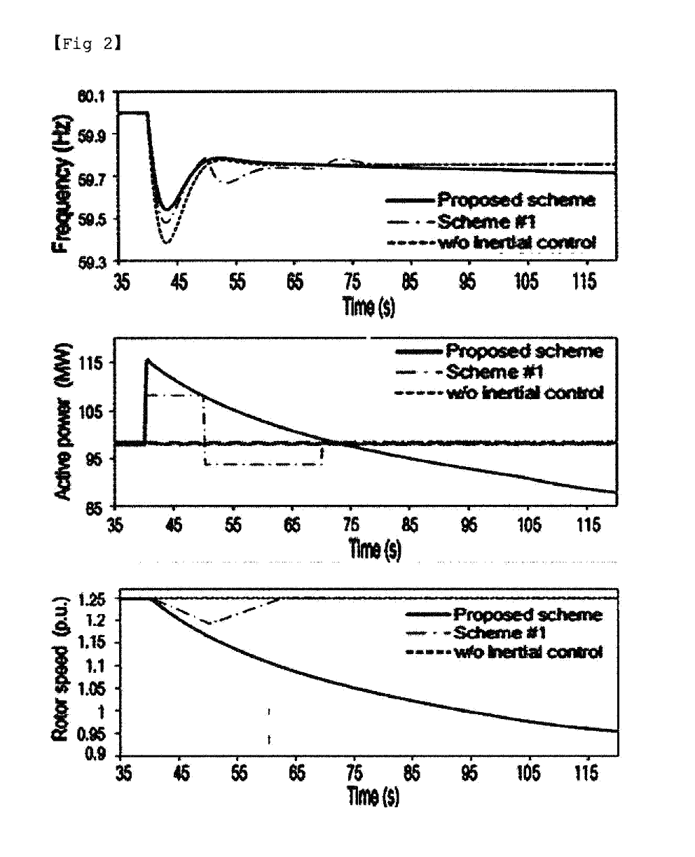

A frequency reduction level, output power of a wind power plant, and a rotor speed according to the present invention and the prior art (prior art document 3) will be described in detail with reference to FIGS. 2 to 4.

The graphs of FIGS. 2 to 4 show the system frequency, the active power of a wind power plant, and rotor speed with respect to time, respectively. In each of the graphs, the green dash-dotted line shows a result of applying the method of prior document 3, and a result according to an embodiment of the present invention is shown as a thick solid line. In addition, when inertial control is not performed, it is shown as a dotted line.

Hereinafter, simulation results are described in detail.

FIGS. 2 to 4 show the cases in which the penetration level of wind power generation is 16.7%. FIG. 2 compares the adaptive inertial control method with the method of prior art document 3 when the wind speed is 11 m/s. Seeing the graph of frequency shown at the top of FIG. 2, it is understood that frequency reduction in the method of prior art document 3 is more severe compared with that of the present invention. In addition, the method of prior art document 3 shows a second frequency dip (at fifty two seconds). The present invention shows a stable frequency recovery without the second frequency dip after the frequency nadir (at forty three seconds). On the other hand, seeing the graph of the active power of the wind generator shown in the middle of FIG. 2, the method of prior art document 3 has a section of increased output power for ten seconds after the disturbance occurrence (forty seconds) and a section of decreased output power for twenty seconds after the section of increased output power. Abrupt reduction of output power (0.15 p.u.) occurring between the two sections brings a second frequency dip. Contrarily, in the present invention, since ΔP is calculated to be high according to high kinetic energy of the rotor, the output power reference becomes larger the torque limit of the wind generator, and the output power is confined to the torque limit. The present invention gradually reduces output power of the wind generator according to reduction of the rotor speed after abrupt increase of the output power and prevents a second frequency dip shown in the prior art document 3. On the other hand, seeing the graph of rotor speed of the wind generator shown at the bottom of FIG. 2, in the case of the prior art document 3, the rotor speed is increased again to prevent over-deceleration after the rotor speed is reduced. Contrarily, in the case of the present invention, the rotor speed converges to the intersection of the mechanical input curve and the electric output curve of the wind generator, and since this is a point higher than the minimum limit of the rotor speed, the over-deceleration is prevented.

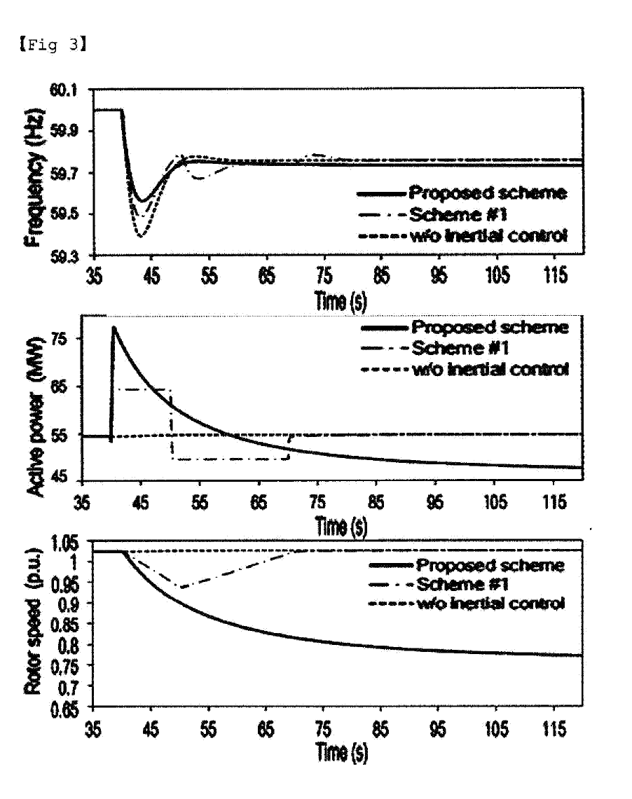

FIG. 3 compares the adaptive inertial control with the method of prior art document 3 when the wind speed is 9 m/s. Seeing the graph of frequency shown at the top of FIG. 3, like as shown in FIG. 2, frequency reduction of the present invention is smaller than that of the method of prior art document 3. Furthermore, the method of prior art document 3 generates a second frequency dip (fifty four seconds) like as shown in FIG. 2. In the case of the present invention, the frequency is recovered stably without a second frequency dip. On the other hand, seeing the graph of the active power of the wind generator shown in the middle of FIG. 3, the method of prior art document 3 shows an output power characteristic the same as that of FIG. 2 and has abrupt reduction of output power ten seconds after a disturbance occurs, and, therefore, a second frequency dip occurs. Contrarily, in the case of the present invention, output power is abruptly increased by adding predetermined ΔP for the wind speed of 9 m/s, and this greatly contributes to increase of the system frequency nadir after a disturbance occurs. In addition, the output power gradually decreased after the output power is increased without generating a second frequency dip. On the other hand, seeing the graph of rotor speed shown at the bottom of FIG. 3, in the case of the prior art document 3, the rotor speed is recovered to prevent the over-deceleration after the rotor speed is reduced. Contrarily, in the case of the present invention, the over-deceleration is prevented as the rotor speed converges.

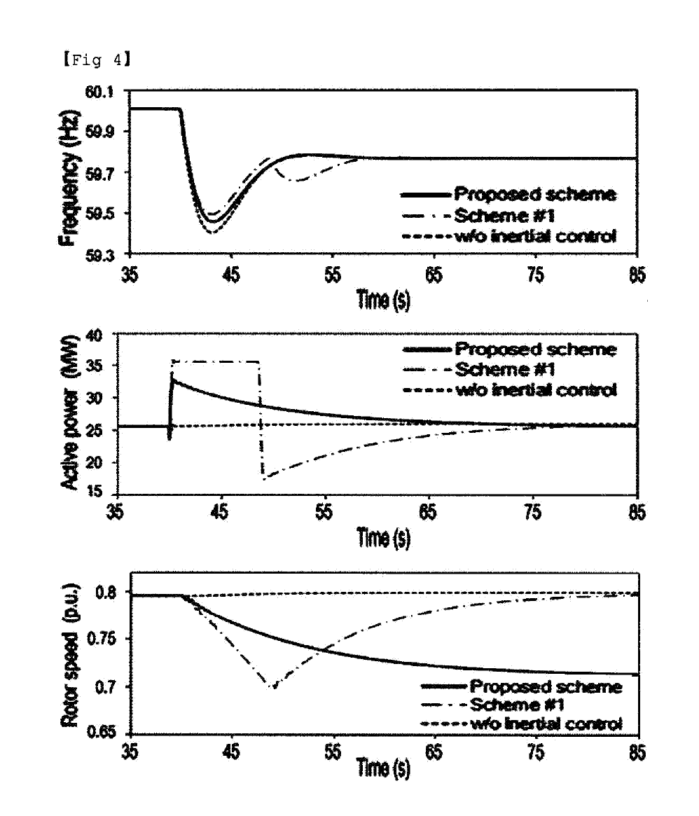

FIG. 4 compares the present invention with the method of prior art document 3 when the wind speed is 7 m/s. Since the input wind speed is low, the wind generator has low kinetic energy. Seeing the graph of the active power of the wind generator shown in the middle of FIG. 4, the method of prior art document 3 has a large increment of output power regardless of the low kinetic energy of the wind generator. Accordingly, since the inertial control is deactivated and output power reference is switched to that of the MPPT control (forty seven seconds) due to the over-deceleration during the inertial control, a phenomenon of extremely large output reduction occurs. Contrarily, ΔP of the present invention calculated at an optimum rotor speed corresponding to 7 m/s has a value smaller than that of the method of prior art document 3. On the other hand, seeing the graph of rotor speed shown at the bottom of FIG. 4, the method of prior art document 3 causes over-deceleration (forty seven seconds). Contrarily, as a small ΔP is added, the present invention prevents the over-deceleration phenomenon since reduction of the rotor speed is small and the rotor speed converges at a speed higher than a minimum speed.

Comprehensively considering FIGS. 2 to 4, although the prior art document 3 contributes to increase of the frequency nadir after a disturbance, it generates a second frequency dip. Particularly, when the wind speed is low, the over-deceleration is easily generated since the characteristic of the rotor speed of the generator is not considered, and a second frequency dip further severe than the first frequency dip occurs and acts as a disturbance extremely critical to the system. Contrarily, the present invention can stably contribute to increase of the frequency nadir and recovery of the frequency and prevent a second frequency dip while preventing the over-deceleration by calculating the additional active power taking into account the rotor speed of the generator.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An output power control method of a wind generator, the method comprising:
an output power increasing step for, when a disturbance occurs, increasing output power of the wind generator by adding the active power proportional to kinetic energy stored in the wind generator at the instant of a disturbance,
wherein the output power increasing step calculates an increment of the output power by using a mechanical input curve and an electrical output curve at a corresponding wind speed of the wind generator, and
wherein the increment of the output power is determined as a constant which makes the mechanical input curve of the wind generator and the electrical output curve intersect at least at one point according to each input wind speed, and when an intersection determined above is formed at a rotor speed lower than ωₘᵢₙ, the increment of the output power is determined as a maximum constant value which makes the rotor speed reach a predetermined point.

2. The method according to claim 1, wherein the output power increasing step increases output power of the wind generator by adding the calculated increment of the output power to an output power reference for Maximum Power Point Tracking control.

3. The method according to claim 1, wherein when a wind power plant including multiple wind generators is controlled, the output power increasing step increases output power of each wind generator in proportion to individual wind speed of each wind generator at the instant of a disturbance.

4. The method according to claim 3, wherein the individual wind speed is a speed reflecting the wake effect of the wind generator.

5. The method according to claim 1, wherein the output power increasing step increases the output power by reflecting a control range of the rotor speed of the wind generator.

6. The method according to claim 1, wherein the output power increasing step decreases or increases the increment of the output power when the wind speed decreases or increases while inertial control is performed.

7. (canceled)

8. The method according to claim 1, wherein the increment of the output power is determined by multiplying a value set in proportion to the kinetic energy by a weighting factor proportional to a maximum rate of change of system frequency at the instant of a disturbance.

9. The method according to claim 8, wherein the electrical output power curve reflecting the increment of the output power is determined by
P_{ref}=[Σₘ₌₀(kₙ₋ₘ*ω^{n-m})]+α*ΔP.
